(19) United States
(12) Patent Application Publication
(10) Pub. No.: US 2026/0112930 A1
(43) Pub. Date: Apr. 23, 2026

(54) ROTOR

(71) Applicant: TOYOTA JIDOSHA KABUSHIKI KAISHA, Toyota-shi (JP)

(72) Inventor: Yuki Shimokobe, Shinshiro-shi (JP)

(73) Assignee: TOYOTA JIDOSHA KABUSHIKI KAISHA, Toyota-shi (JP)

(21) Appl. No.: 19/283,740

(22) Filed: Jul. 29, 2025

(30) Foreign Application Priority Data
Oct. 22, 2024 (JP) 2024-185788

(51) Int. Cl. H02K 1/32

(52) U.S. Cl. CPC H02K 1/32

(57) ABSTRACT

The present disclosure relates to a rotor. The rotor includes a rotor shaft and a rotor core that is attached to the rotor shaft and configured to be rotatable together with the rotor shaft. The rotor core has a plurality of holes extending from its surface to the rotor shaft.

### CROSS-REFERENCE TO RELATED APPLICATION

This application claims priority to Japanese Patent Application No. 2024-185788 filed on Oct. 22, 2024. The disclosure of the above-identified application, including the specification, drawings, and claims, is incorporated by reference herein in its entirety.

### BACKGROUND

### 1. Technical Field

Technology that is disclosed in the present specification relates to a rotor. In particular, the technology that is disclosed in the present specification relates to a rotor for a motor.

### 2. Description of Related Art

Japanese Unexamined patent Application Publication No. 2001-190047 (JP 2001-190047 A) discloses a rotor in which a cooling oil passage following an axial direction is formed in a yoke portion. With the rotor according to JP 2001-190047 A, lubricating oil is supplied to the cooling oil passage through a supply passage by an oil pump, thereby cooling the rotor.

### SUMMARY

With the rotor according to JP 2001-190047 A, the oil pump is used to supply the lubricating oil to the cooling oil passage, and accordingly the number of components of the motor is greater. In the present specification, technology for efficiently cooling a rotor with a simple configuration is provided.

The technology that is disclosed in the present specification is embodied in a rotor for a motor.

The rotor includes
a rotor shaft, and
a rotor core that is attached to the rotor shaft and that is configured to be rotatable with the rotor shaft.

A plurality of holes pass through from a surface of the rotor core to the rotor shaft.

When the rotor rotates, a circumferential speed on an inner diameter side of the rotor becomes higher than a circumferential speed on an outer diameter side of the rotor. In the rotor that is described above, the rotor core has multiple holes that pass through from the surface thereof to the rotor shaft. Accordingly, inside of each of the holes, air pressure on the inner diameter side of the rotor becomes lower than air pressure on the outer diameter side of the rotor, due to difference in the circumferential speed between the inner diameter side and the outer diameter side of the rotor. When the rotor rotates, air flows to inside of each of the holes so as to be drawn from the outer diameter side to the inner diameter side of the rotor, due to this air pressure difference. Thus, inside of the rotor core can be air-cooled. Accordingly, in the above-described configuration, the rotor can be efficiently cooled with a simple configuration.

According to an embodiment of the present technology, the holes may be inclined with respect to a radial direction of the rotor, as viewed along an axial direction of the rotor. In such a configuration, for example, rotating the rotor such that an inclination direction of each of the holes matches a rotation direction of the rotor enables air to be made to efficiently flow into the inside of each of the holes.

In an embodiment of the present technology, a position of each of the holes may be a different position in a circumferential direction of the rotor. In such a configuration, the holes can be arranged in a well-balanced manner along the circumferential direction of the rotor, and accordingly cooling efficiency of the entire rotor can be made to be uniform.

In an embodiment of the present technology, the holes that are adjacent to each other in the circumferential direction of the rotor may be at different positions in the axial direction of the rotor. In such a configuration, the holes can be arranged in a well-balanced manner along the axial direction of the rotor, and accordingly cooling efficiency of the entire rotor can be made to be uniform.

The technology that is disclosed in the present specification is embodied in another rotor for a motor.

The rotor includes
a rotor shaft, and
a rotor core that is attached to the rotor shaft and that is configured to be rotatable with the rotor shaft.

A surface of the rotor core is provided with a groove extending spirally from one end of the rotor to another end of the rotor in an axial direction, and
the groove is configured such that a cross-sectional area of the groove decreases from the one end toward the other end.

In the rotor that is described above, when the rotor rotates, air flows along the inside of each of the grooves in addition to the surface of the rotor core. Since the surface area of the rotor core is increased by a plurality of the grooves, the rotor can be air-cooled efficiently. Further, each of the grooves that is provided on the surface of the rotor core extends in a spiral shape, and also is configured such that the cross-sectional area thereof decreases from one end of the rotor toward the other end of the rotor in the axial direction. Flow velocity of the air flowing in the groove becomes faster as the cross-sectional area of the groove becomes smaller. For this reason, for example, rotating the rotor such that the rotation direction from the one end of the groove toward the other end thereof is opposite to the rotation direction of the rotor causes air to flow while accelerating in the groove. Thus, the rotor can be air-cooled efficiently. Accordingly, in the above-described configuration, the rotor can be efficiently cooled with a simple configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a motor 2 including a rotor 10 according to a first embodiment;

FIG. 2 is a perspective view of a rotor 10 according to a first embodiment;

FIG. 3 is a cross-sectional view of the rotor 10 according to the first embodiment;

FIG. 4 is a cross-sectional view of a rotor 100 according to a second embodiment, the cross-sectional view corresponding to FIG. 3; and

FIG. 5 is a perspective view of a rotor 200 according to a third embodiment.

### DETAILED DESCRIPTION OF EMBODIMENTS

### Example 1

The rotor 10 of the first embodiment and the motor 2 including the rotor 10 will be described with reference to the drawings. Although not particularly limited, the motor 2 can be employed in an electrified vehicle as a prime mover for driving wheels. Electrified vehicle includes, for example, a battery electrified vehicle, a hybrid electrified vehicle, a plug-in hybrid electrified vehicle, and a fuel cell electrified vehicle.

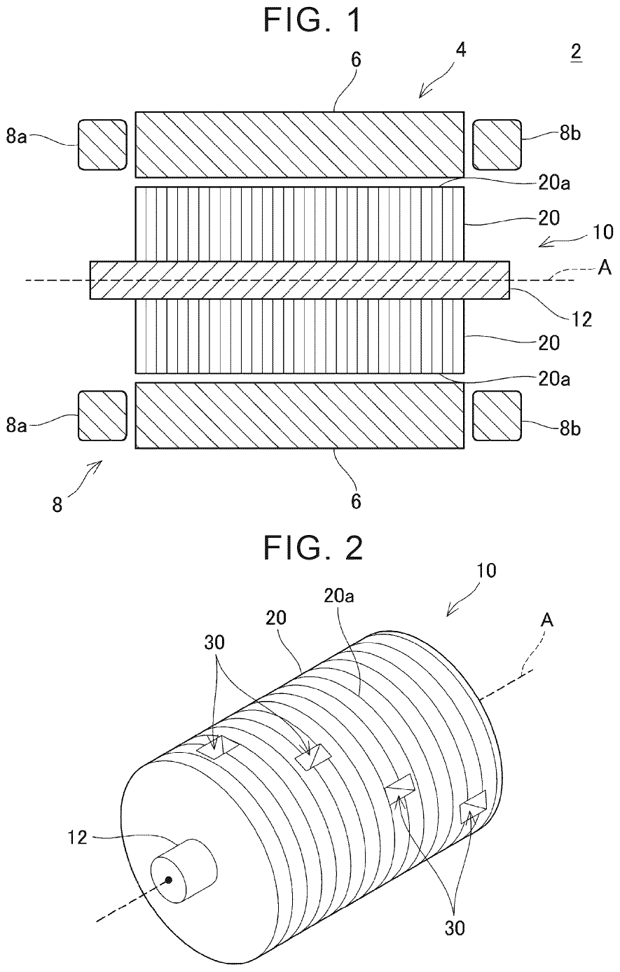

As shown in FIG. 1, the motor 2 includes a stator 4 and a rotor 10. The stator 4 includes a stator core 6 and a coil 8. The stator core 6 is made of a soft magnetic material. As an example, the stator core 6 of the present embodiment has a structure in which a plurality of electromagnetic steel sheets (not shown) are laminated. The stator core 6 has a cylindrical shape extending along the axial direction (the direction along the rotation axis A). The stator core 6 is disposed on the outer periphery of the rotor core 20 at a predetermined distance from the rotor core 20. The coil 8 is formed of a conductive wire having an insulating coating, and is passed through the stator core 6. The coil 8 includes coil end 8a, 8b protruding outward from respective axial direction end faces of the stator core 6.

The rotor 10 is located inside the stator 4. The rotor 10 is spaced apart from the stator 4. The rotor 10 includes a rotor shaft 12 and a rotor core 20. The rotor shaft 12 is supported by a bearing attached to a housing (not shown) of the motor 2 so as to be rotatable about the rotation axis A.

The rotor core 20 is fixed to the rotor shaft 12 and is configured to be rotatable together with the rotor shaft 12 about the rotation axis A. The rotor core 20 is made of a soft magnetic material. As an example, the rotor core 20 of the present embodiment has a structure in which a plurality of electromagnetic steel sheets are stacked in the axial direction. The rotor core 20 is provided with a plurality of permanent magnets (not shown) along the circumferential direction of the rotor 10.

As shown in FIGS. 2 and 3, the rotor core 20 has a plurality of holes 30. As shown in FIG. 3, the holes 30 extend from the surface 20a of the rotor core 20 to the rotor shaft 12. The number of the holes 30 is not particularly limited, but in the present embodiment, eight holes 30 are provided in the rotor core 20. Each hole 30 extends linearly along the radial direction of the rotor 10. The holes 30 are provided at different positions in the circumferential direction of the rotor 10. The holes 30 are arranged at equal intervals along the circumferential direction. As shown in FIG. 2, the two holes 30 adjacent to each other in the circumferential direction of the rotor 10 have different positions in the axial direction. In the present embodiment, the holes 30 are arranged in a spiral shape along the axial direction. The cross-sectional shape of each hole 30 is not particularly limited, but may be, for example, a rectangular shape, a circular shape, or the like. Note that each hole 30 can be formed by, for example, a punching process after the electrical steel sheets are laminated. It should be noted that the stator 4 is not shown in FIGS. 2, 3 and 4 to 6 described later.

Next, an aspect of cooling the rotor 10 will be described. When the rotor 10 rotates, the circumferential speed of the rotor 10 on the inner diameter side (i.e., the rotor shaft 12 side) becomes higher than the circumferential speed of the rotor 10 on the outer diameter side (i.e., the surface 20a side). Therefore, in the inside of each hole 30, the air pressure on the inner diameter side of the rotor 10 becomes lower than the air pressure on the outer diameter side of the rotor 10 due to the difference between the circumferential speed on the inner diameter side and the outer diameter side of the rotor 10. When the rotor 10 rotates due to the difference in atmospheric pressure, air flows into the respective holes 30 so as to be drawn from the outer diameter side to the inner diameter side of the rotor 10. This makes it possible to air-cool the inside of the rotor core 20. Therefore, in the rotor 10 of the first embodiment, it is possible to efficiently cool the rotor 10 with a simple configuration.

In the rotor 10 of the first embodiment, the positions of the holes 30 in the circumferential direction are different, and the positions of the holes 30 adjacent to each other in the circumferential direction are different in the axial direction. Therefore, the holes 30 are arranged in a well-balanced manner along the circumferential direction and the axial direction of the rotor 10, so that the cooling efficiency of the entire rotor 10 can be made uniform.

In addition, the rotor 10 of the first embodiment is air-cooled by the rotation of the rotor 10 itself as described above. Therefore, a member for cooling the rotor 10 is not separately required. The member for cooling the rotor 10 is, for example, a fan for air-cooling the rotor, an oil pump for supplying a refrigerant for cooling the rotor, a supply passage for supplying the refrigerant, or the like. Therefore, the number of components of the motor 2 can be reduced. Further, since the rotor 10 of the first embodiment is cooled by air (gas), the resistance to the rotation of the rotor 10 is small compared with the cooling by the liquid refrigerant, and the loss of the motor 2 can be reduced.

### Example 2

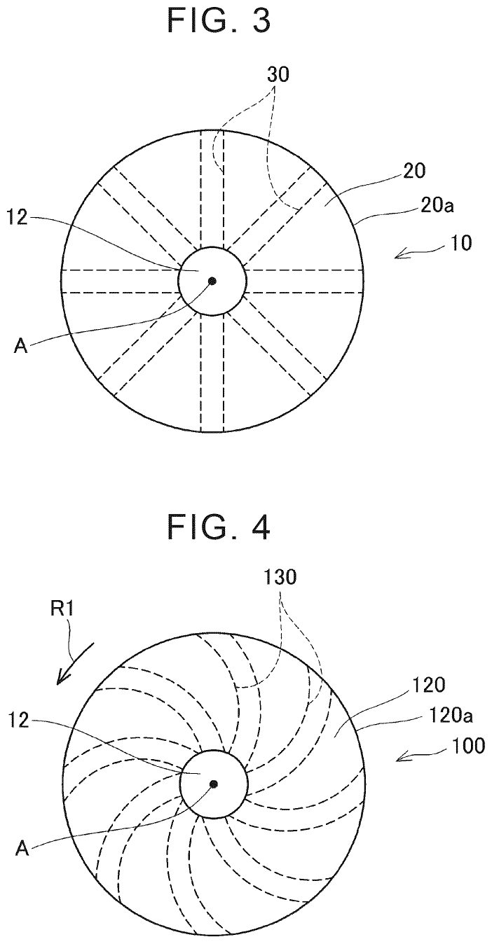

Next, the rotor 100 of the second embodiment will be described. FIG. 4 is a cross-sectional view corresponding to FIG. 3 of Example 1. The rotor 100 of the second embodiment differs from the first embodiment in the configuration of the plurality of holes 130 provided in the rotor core 120. The other configurations are the same as those of the first embodiment.

As shown in FIG. 4, each hole 130 is inclined with respect to the radial direction of the rotor 100 when viewed along the axial direction. More specifically, each hole 130 extends while being curved so as to be concave in the inclination direction thereof. The holes 130 are arranged at equal intervals along the circumferential direction as in the first embodiment. In addition, as in the first embodiment, the holes 130 are arranged so as to be arranged spirally along the axial direction on the surface 120a of the rotor core 120. Each hole 130 can be formed, for example, by performing processing corresponding to each hole 130 on each electromagnetic steel sheet constituting the rotor core 120, and then laminating the electromagnetic steel sheets while aligning them.

Also in the rotor 100 of the second embodiment, as in the first embodiment, air flows into the inside of each hole 130 by using the air pressure difference between the outer diameter side and the inner diameter side of the rotor 100 due to the rotation of the rotor 100. This makes it possible to air-cool the inside of the rotor core 120.

Further, in the rotor 100 of the second embodiment, by rotating the rotor 100 so that the inclination direction of each hole 130 coincides with the rotation direction of the rotor 100, it is possible to efficiently flow air into the inside of each hole 130. For example, when the motor 2 including the rotor 100 is employed in electrified vehicle, it is effective to set the rotational direction of the rotor 100 corresponding to the forward rotation direction of the wheels (the forward direction of the vehicles) to the direction R1 in FIG. 4. In general, since the forward movement of the vehicle is more frequent than the backward movement of the vehicle, the frequency of heat generation by the motor 2 is also increased. Therefore, by setting the direction R1 to the rotational direction of the rotor 100 corresponding to the forward direction of the vehicle, the rotor 100 can be cooled more efficiently.

In the first and second embodiments described above, the plurality of holes 30 and 130 may be provided along the axial direction at the same angular position in the circumferential direction of the rotor cores 20 and 120. Further, the holes 30 and 130 adjacent to each other in the circumferential direction may be provided at the same position in the axial direction.

In the second embodiment, the holes 130 may not be curved. For example, each hole 130 may have a linear shape that is inclined with respect to the radial direction. Further, in the second embodiment, the inclination direction of each hole 130 may be reversed.

### Example 3

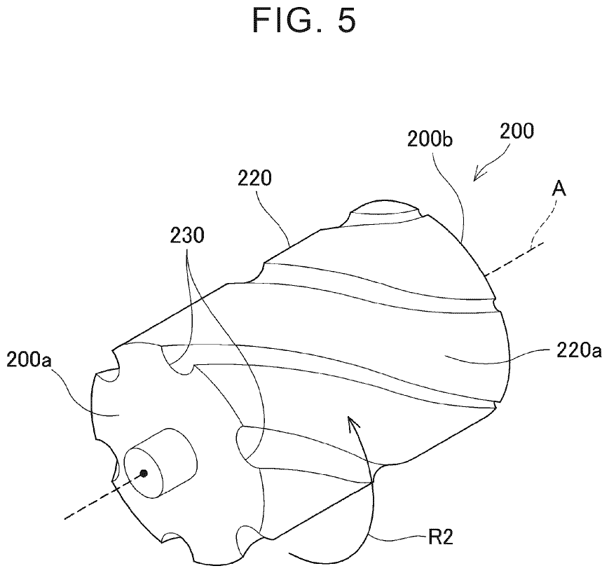

Next, the rotor 200 of the third embodiment will be described. FIG. 5 is a perspective view corresponding to FIG. 2 of Example 1. In the rotor 200 of the third embodiment, a plurality of grooves 230 are provided on the surface 220a of the rotor core 220 instead of the holes 30 of the first embodiment. The other configurations are the same as those of the first embodiment.

As shown in FIG. 5, the grooves 230 extend from one axial direction end 200a of the rotor 200 to the other end 200b. Each groove 230 extends in a spiral shape along the axial direction. Each of the grooves 230 is configured to have a cross-sectional area decreasing from one end 200a to the other end 200b. Specifically, as shown in FIG. 5, the grooves 230 are configured to gradually become narrower from one end 200a toward the other end 200b. Further, the respective grooves 230 are configured such that their depths gradually become shallower from one end 200a toward the other end 200b. Each of the grooves 230 can be formed, for example, by performing processing corresponding to each of the grooves 230 on each of the electromagnetic steel sheets constituting the rotor core 220, and then laminating the electromagnetic steel sheets while aligning them.

In the rotor 200 of the third embodiment, when the rotor 200 rotates, air flows along the inside of the grooves 230 in addition to the surface 220a of the rotor core 220. In the third embodiment, since the surface area of the rotor core 220 is increased by the plurality of grooves 230, the rotor core 220 can be efficiently air-cooled. Therefore, in the above-described configuration, the rotor 200 can be cooled efficiently with a simple configuration.

Further, the grooves 230 are configured to extend in a spiral shape along the axial direction, and have a cross-sectional area decreasing from one end 200a toward the other end 200b. The flow velocity of the air flowing in the groove 230 becomes faster as the cross-sectional area of the groove 230 becomes smaller. Therefore, by rotating the rotor 200 such that the rotational direction from one end 200a to the other end 200b of each groove 230 is opposite to the rotational direction of the rotor 200, air flows while accelerating in the groove 230, and the rotor core 220 can be efficiently air-cooled. For example, when the motor 2 including the rotor 200 is employed in electrified vehicle, it is effective to set the rotational direction of the rotor 200 corresponding to the forward rotation direction of the wheels (the forward direction of the vehicles) to the direction R2 in FIG. 5. When the direction R2 is the rotational direction of the rotor 200 corresponding to the forward direction of the vehicle, the rotor 200 can be cooled more efficiently.

In the third embodiment described above, it is sufficient that the respective grooves 230 have a cross-sectional area decreasing from one end 200a toward the other end 200b. For example, the depth of the grooves 230 may be made constant so that only the depth from one end 200a toward the other end 200b becomes shallow. In addition, the depth of the respective grooves 230 may be made constant, so that only the depth is narrowed from one end 200a toward the other end 200b.

What is claimed is:

1. A rotor for a motor, the rotor comprising:
a rotor shaft; and
a rotor core that is attached to the rotor shaft and that is configured to be rotatable with the rotor shaft, wherein
a plurality of holes pass through from a surface of the rotor core to the rotor shaft.

2. The rotor according to claim 1, wherein the holes are inclined with respect to a radial direction of the rotor, as viewed along an axial direction of the rotor.

3. The rotor according to claim 1, wherein a position of each of the holes is a different position in a circumferential direction of the rotor.

4. The rotor according to claim 3, wherein the holes that are adjacent to each other in the circumferential direction of the rotor are at different positions in the axial direction of the rotor.

5. A rotor for a motor, the rotor comprising:
a rotor shaft; and
a rotor core that is attached to the rotor shaft and that is configured to be rotatable with the rotor shaft, wherein
a surface of the rotor core is provided with a groove extending spirally from one end of the rotor to another end of the rotor in an axial direction, and
the groove is configured such that a cross-sectional area of the groove decreases from the one end toward the other end.
